(19) United States
(12) Patent Application Publication
(10) Pub. No.: US 2017/0147534 A1
(43) Pub. Date: May 25, 2017

(54) TRANSFORMATION OF THIRD-PARTY CONTENT FOR NATIVE INCLUSION IN A PAGE

(71) Applicant: Microsoft Technology Licensing, LLC, Redmond, WA (US)

(72) Inventors: Kaushik Sethuraman, Redmond, WA (US); Sylvia Ho, Issaquah, WA (US); Stephen Giff, Redmond, WA (US); Sandeep Wali, San Jose, CA (US)

(21) Appl. No.: 14/948,773

(22) Filed: Nov. 23, 2015

(51) Int. Cl. G06F 17/21; G06F 3/0481; H04L 29/08

(52) U.S. Cl. CPC G06F 17/212; H04L 67/22; H04L 67/02; G06F 3/0481

(57) ABSTRACT

Various technologies described herein pertain to creating transformed third-party content for inclusion in a page of a publisher for display on a client computing device. A request for the page of the publisher generated by the client computing device can be received. In response to receiving the request, a template for the transformed third-party content can be selected based on an identity of the publisher of the page and a type of the page. Further, in response to receiving the request, third-party content from a data repository comprising available third-party content can be selected. The third-party content can be selected based on publisher provided content in the page. The third-party content can be formatted according to the template to compose the transformed third-party content. Moreover, the transformed third-party content can be transmitted to the client computing device for native inclusion in the page amongst the publisher provided content.

### BACKGROUND

Search engine results pages returned responsive to searches performed by a search engine oftentimes include third-party content. A search engine returns search results responsive to a query, and the search results can be included in a search engine results page (e.g., displayed on a display of a computing device). The search engine results page can also include third-party content, which differs from the search results. For instance, third-party content and search results are typically positioned in separate regions within search engine results pages (e.g., the third-party content may be positioned above the search results in a search engine results page, the third-party content may be positioned to the side of the search results in a search engine results page). Moreover, the third-party content is oftentimes accompanied by an indicator that distinguishes the third-party content from the search results (e.g., the indicator can be an image such as an icon, the indicator can be text).

Third-party content in search engine results pages typically includes text-based content. Third-party content for inclusion in search engine results pages is commonly supplied along with keywords (e.g., when creating a campaign for the third-party content). Thus, the third-party content can be targeted to match key search terms (e.g., keywords) in queries inputted to the search engine. Accordingly, third-party content included in a search engine results page returned responsive to a query can be relevant to a search performed by the search engine.

### SUMMARY

Described herein are various technologies that pertain to creating transformed third-party content for inclusion in a page of a publisher. The page can be for display on a client computing device. A content distribution computing system can include a data repository that comprises available third-party content. The available third-party content in the data repository can be maintained in a format for inclusion in search engine results pages returned responsive to searches performed by a search engine. The content distribution computing system can receive a request for the page of the publisher. The request can be generated by the client computing device upon which the page is to be displayed. In response to receiving the request for the page, a template for the transformed third-party content can be selected based on an identity of the publisher of the page and a type of the page. The type of the page can be one of a plurality of predefined types of pages. Further, in response to receiving the request for the page, third-party content from the data repository comprising the available third-party content can be selected. The third-party content can be selected based on publisher provided content in the page. The third-party content can further be selected based on search history of a user of the client computing device, browsing history of the user of the client computing device, and so forth. The third-party content can be formatted according to the template to compose the transformed third-party content. Moreover, the transformed third-party content can be transmitted to the client computing device for native inclusion in the page amongst the publisher provided content. Accordingly, the third-party content supplied for inclusion in a search engine results page returned responsive to a search performed by a search engine can be converted to the transformed third-party content, which can natively be inserted amongst the publisher provided content of the page of the publisher (e.g., for display on the display of the client computing device).

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that transforms third-party content for native inclusion in a page of a publisher.

FIG. 2 illustrates a functional block diagram of another exemplary system that distributes transformed third-party content for inclusion in the page of the publisher.

FIG. 3 illustrates a functional block diagram of an exemplary composition component of an exemplary content distribution computing system in greater detail.

FIG. 4 illustrates a functional block diagram of an exemplary system that includes the content distribution computing system.

FIG. 5 illustrates a functional block diagram of an exemplary client computing device.

FIGS. 6-7 illustrate user interfaces that can be displayed (e.g., on a display of a client computing device) for two exemplary predefined types of pages for a publisher.

FIG. 8 illustrates exemplary templates for third-party content to be included in pages amongst publisher provided content

FIG. 9 illustrates a functional block diagram of another exemplary client computing device.

FIG. 10 is a flow diagram that illustrates an exemplary methodology of creating transformed third-party content for inclusion in a page of a publisher.

FIG. 11 is a flow diagram that illustrates an exemplary methodology of requesting transformed third-party content for native inclusion amongst publisher provided content of a page of a publisher.

FIG. 12 illustrates an exemplary computing device.

FIG. 13 illustrates an exemplary computing system.

### DETAILED DESCRIPTION

Various technologies pertaining to converting third-party content, which is maintained in a format for inclusion in a search engine results page returned responsive to a search performed by a search engine, into transformed third-party content for native inclusion in a page of a publisher amongst publisher provided content are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

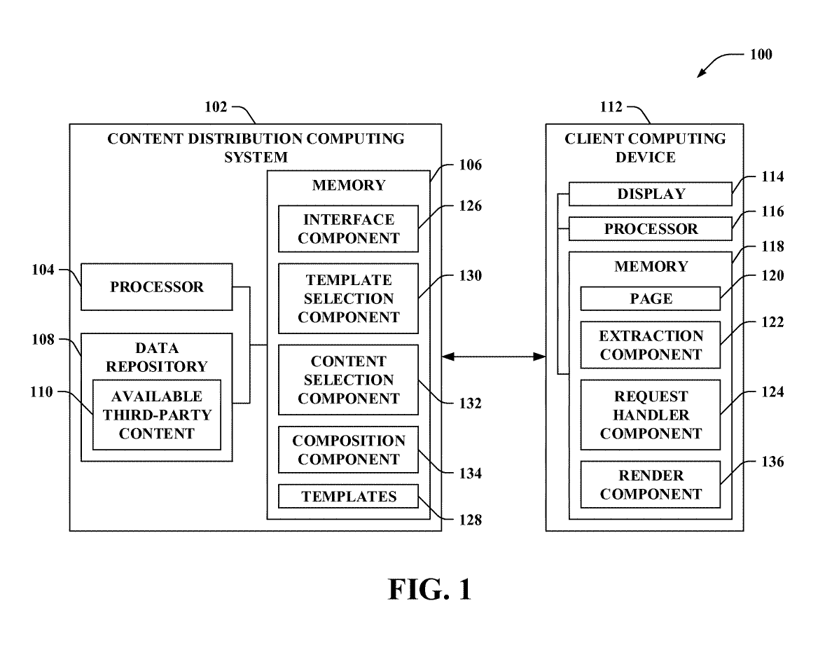

Referring now to the drawings, FIG. 1 illustrates a system 100 that transforms third-party content for native inclusion in a page of a publisher. The system 100 includes a content distribution computing system 102 configured to create transformed third-party content for inclusion in a page of a publisher. The content distribution computing system 102 includes at least one processor 104, memory 106, and a data repository 108. The processor 104 is configured to execute instructions loaded into the memory 106 (e.g., one or more systems loaded into the memory 106 are executable by the processor 104, one or more components loaded into the memory 106 are executable by the processor 104). As described in greater detail herein, the memory 106 includes instructions for creating transformed third-party content which can be sent to a client computing device for native inclusion in a page of a publisher amongst publisher provided content of the page.

The content distribution computing system 102 can be or include one or more server computing devices. For instance, the content distribution computing system 102 can be or include one or more data centers, where a data center includes a plurality of server computing devices. Additionally or alternatively, the content distribution computing system 102 can be a distributed computing system.

The data repository 108 includes available third-party content 110. The available third-party content 110 retained in the data repository 108 is maintained in a format for inclusion in search engine results pages returned responsive to searches performed by a search engine. The available third-party content 110 was previously supplied along with keywords. The available third-party content 110 may have been supplied by parties when creating campaigns for the available third-party content 110 to be returned as part of the search engine results pages (e.g., the parties can include parties other than a publisher of a page and/or the publisher of the page. According to an example, the available third-party content 110 can include plain text content; however, the claimed subject matter is not so limited (e.g., the available third-party content 110 can additionally include images).

The memory 106 of the content distribution computing system 102 can include instructions for selecting third-party content from the available third-party content 110 included in the data repository 108 for a page of a publisher and transforming the selected third-party content for native inclusion in the page of the publisher. Accordingly, the third-party content can be converted from a format for inclusion in a search engine results page returned responsive to a search performed by a search engine to a format for native inclusion in a page of a publisher. The transformed third-party content can naturally look, feel, and behave like publisher provided content included in the page of the publisher amongst which the transformed third-party content is included. Moreover, the transformed third-party content can be relevant to a topic or category of the publisher provided content where the transformed third-party content surfaces in the page.

The system 100 further includes a client computing device 112, which can receive the transformed third-party content from the content distribution computing system 102. Pursuant to various examples, the client computing device 112 can be a desktop computing device, a mobile computing device (e.g., a laptop computing device, a mobile telephone, a smartphone, a tablet computing device, a wearable computing device, a handheld computing device, a portable gaming device, a personal digital assistant, a camera), a gaming console, an in-vehicle communications and infotainment system, or the like. While one client computing device is depicted in FIG. 1, it is to be appreciated that the content distribution computing system 102 can provide transformed third-party content to substantially any number of client computing devices that can each be substantially similar to the client computing device 112. Accordingly, the description of the client computing device 112 set forth herein can be extended to other client computing devices.

The client computing device 112 includes a display 114, at least one processor 116, and memory 118. The processor 116 is configured to execute instructions loaded into the memory 118 (e.g., one or more systems loaded into the memory 118 are executable by the processor 116, one or more components loaded into the memory 118 are executable by the processor 116). As described in greater detail herein, the memory 118 can include instructions for generating a request for transformed third-party content for inclusion in a page 120 and inserting such transformed third-party content in the page 120, which can be displayed on the display 114 of the client computing device 112.

The client computing device 112 can receive the page 120 to be displayed on the display 114. The page 120 is from a publisher and includes publisher provided content. The publisher provided content of the page 120 is content included in the page 120 by the publisher of the page 120 (in contrast to the transformed third-party content which is not provided by the publisher of the page 120).

The memory 118 of the client computing device 112 can include an extraction component 122 configured to extract content from the publisher provided content of the page 120. The extraction component 122, for instance, can extract a title from the publisher provided content of the page 120, a snippet from the publisher provided content of the page 120, or the like. By way of example, the extraction component 122 can determine one or more keywords from the publisher provided content of the page 120. Pursuant to another example, one or more keywords can be determined (e.g., by the content distribution computing system 102) based on the extracted content from the publisher provided content of the page 120.

The memory 118 of the client computing device 112 can further include a request handler component 124 configured to generate a request for the page 120 of the publisher. The request can include the extracted content obtained by the extraction component 122. The request can also include an identifier specifying a user of the client computing device 112, an Internet Protocol (IP) address of the page 120, a Uniform Resource Locator (URL) of the page 120, and so forth.

Moreover, the request handler component 124 can transmit the request to the content distribution computing system 102. The request can be transmitted to the content distribution computing system 102 to cause the content distribution computing system 102 to return transformed third-party content, which can be inserted in the page 120 of the publisher amongst the publisher provided content. In contrast to the publisher provided content which is included in the page 120 by the publisher of the page 120, the publisher does not control selection or creation of the transformed third-party content inserted into the page 120.

The memory 106 of the content distribution computing system 102 can include an interface component 126 configured to receive the request for the page 120 of the publisher generated by the client computing device 112 (e.g., the request sent by the request handler component 124). Moreover, it is to be appreciated that the interface component 126 of the content distribution computing system 102 can similarly receive requests for differing pages (other than the page 120) from the client computing device 112. It is also contemplated that the interface component 126 of the content distribution computing system 102 can receive requests (for the page 120 and/or differing pages) from differing client computing device(s) other than the client computing device 112.

The content distribution computing system 102 includes a plurality of templates 128. The templates 128 are predefined, and include metadata specifying respective structures to which transformed third-party content generated by the content distribution computing system 102 conform. According to an example, the templates 128 can be for one publisher. According to another example, the templates 128 can include a first subset for a first publisher, a second subset for a second publisher, and so forth. It is contemplated that a template (from the templates 128) can be for more than one publisher; yet, the claimed subject matter is not so limited (e.g., none of the templates 128 may be for more than one publisher). The memory 106 can include the templates 128; however, it is contemplated that the templates 128 additionally or alternatively can be retained in a data repository (e.g., the data repository 108, a differing data repository) of the content distribution computing system 102.

The memory 106 of the content distribution computing system 102 can further include a template selection component 130. In response to receiving the request for the page 120, the template selection component 130 can select a template for transformed third-party content from the templates 128. The template selection component 130 can select the template for the transformed third-party content based on an identity of the publisher of the page 120 and a type of the page. The type of the page can be one of a plurality of predefined types of pages. For instance, the predefined types of pages for a website of a publisher can include a homepage, one or more vertical landing pages for differing categories (e.g., a vertical landing page for sports, a vertical landing page for lifestyle, a vertical landing page for entertainment), and article pages. Yet, it is to be appreciated that substantially any predefined type of page is intended to fall within the scope of the hereto appended claims. Thus, the template selection component 130 can select the template from a plurality of predefined templates for the publisher (e.g., the templates 128 include the plurality of predefined templates for the publisher).

The memory 106 of the content distribution computing system 102 can also include a content selection component 132. In response to receiving the request for the page 120, the content selection component 132 can select third-party content from the data repository 108 (e.g., the content selection component 132 can select the third-party content from the available third-party content 110 included in the data repository 108). The content selection component 132 can select the third-party content based on the publisher provided content in the page 120. As noted above, the request for the page 120 can include the extracted content obtained by the extraction component 122. Accordingly, the content selection component 132 can select the third-party content from the data repository 108 based on the extracted content.

According to an example, the content selection component 132 can determine one or more keywords from the extracted content included in the request. In accordance with an illustration, the extracted content included in the request can include a title from the publisher provided content of the page 120. Following this illustration, the content selection component 132 can detect one or more keywords from the title. Additionally or alternatively, it is contemplated that the extracted content included in the request can include a snippet from the publisher provided content of the page 120 (e.g., a snippet from a paragraph) or some other portion of the publisher provided content of the page 120; thus, the content selection component 132 can detect one or more keywords from the snippet (or the portion of the publisher provided content) included in the request. By way of another example, the extracted content included in the request can include one or more keywords (e.g., determined by the extraction component 122 of the client computing device 112). The content selection component 132 can select the third-party content from the available third-party content 110 in the data repository 108 based on the one or more keywords. The content selection component 132 can further select the third-party content from the available third-party content 110 based on bids associated with the available third-party content 110.

Moreover, the content selection component 132 can select the third-party content from the available third-party content 110 in the data repository 108 based on search history of a user of the client computing device 112, browsing history of the user of the client computing device 112, or the like. The request can include an identifier specifying the user of the client computing device 112. Thus, the content selection component 132 can employ search history and/or browsing history of the specified user to select the third-party content.

Further, the memory 106 of the content distribution computing system 102 can include a composition component 134 configured to format the third-party content according to the template selected by the template selection component 130 to compose transformed third-party content. The third-party content selected by the content selection component 132 can be formatted according to the template (from the templates 128) selected by the template selection component 130 to compose the transformed third-party content. The transformed third-party content composed by the composition component 134 can have an appearance that conforms with the publisher provided content amongst which the transformed third-party content is to be included in the page 120.

According to an illustration, the third-party content selected from the data repository 108 by the content selection component 132 can include plain text content. The plain text content in the data repository 108 can be maintained in a format for inclusion in a search engine results page returned responsive to a search performed by a search engine. The composition component 134 can convert the plain text content into visually-centric content that looks, feels, behaves, and blends with the publisher provided content in the page 120 into which the transformed third-party content is to be inserted.

The interface component 126 can further transmit the transformed third-party content to the client computing device 112 for native inclusion in the page 120 amongst the publisher provided content. Moreover, the request handler component 124 of the client computing device 112, responsive to transmission of the request, can receive the transformed third-party content from the content distribution computing system 102. The transformed third-party content can be relevant to the extracted content and formatted for native inclusion in the page 120 of the publisher.

The memory 118 of the client computing device 112 can include a render component 136 configured to insert the transformed third-party content amongst the publisher provided content of the page 120. The transformed third-party content can have an appearance that conforms with the publisher provided content amongst which the transform third-party content is inserted in the page 120. The render component 136 can also display, on the display 114, the page 120 with the transformed third-party content as inserted.

The transformed third-party content can look and feel as natural as the publisher provided content. For example, if the publisher provided content in a section of the page 120 has a thumbnail and text with a logo below, then for the transformed third-party content to natively fit in this section, it too can be formatted to have a thumbnail and text with a logo below.

The client computing device 112 can receive input specifying a user selection of the transformed third-party content inserted in the page 120 (e.g., when the page 120 is displayed on the display 114 by the render component 136). Responsive to the input, the client computing device 112 can retrieve a web resource at a destination URL specified by the transformed third-party content. It is to be appreciated, however, that the claimed subject matter is not so limited.

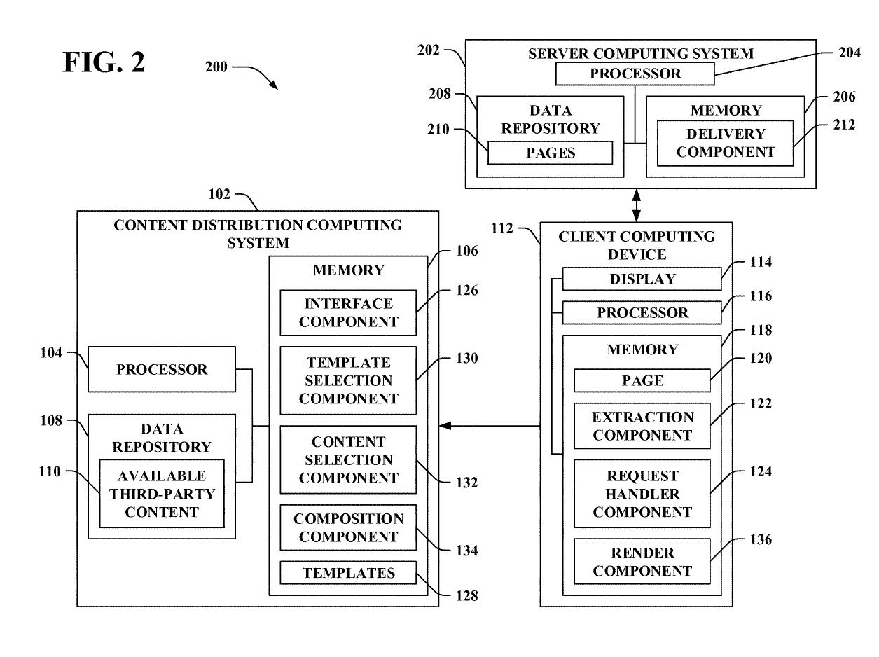

Referring now to FIG. 2, illustrated is another system 200 for distributing transformed third-party content for inclusion in the page 120 of the publisher. Again, the page 120 is to be displayed on the client computing device 112. The system 200 includes the content distribution computing system 102 and the client computing device 112. Moreover, the system 200 includes a server computing system 202.

The server computing system 202 includes at least one processor 204, memory 206, and a data repository 208. The processor 204 is configured to execute instructions loaded into the memory 206 (e.g., one or more systems loaded into the memory 206 are executable by the processor 204, one or more components loaded into the memory 206 are executable by the processor 204). Moreover, the data repository 208 includes pages 210 that can be sent to the client computing device 112 and/or differing client computing device(s). The pages 210 can include pages of one publisher, for example. According to another example, the pages 210 can include pages of a plurality of publishers.

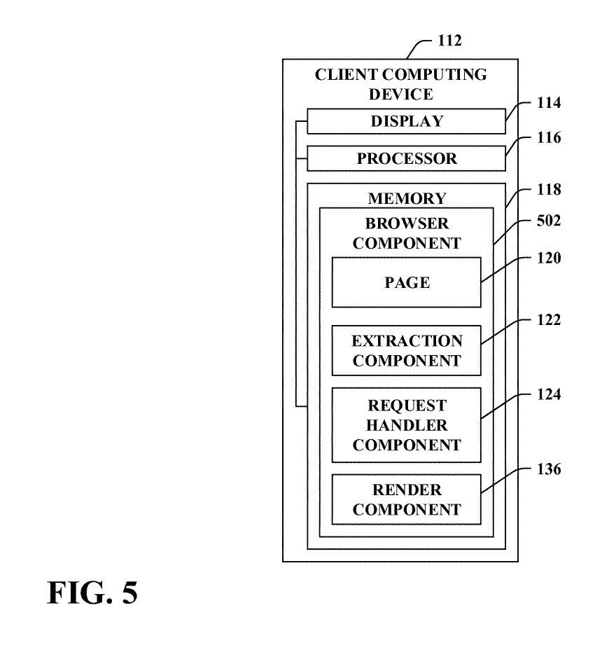

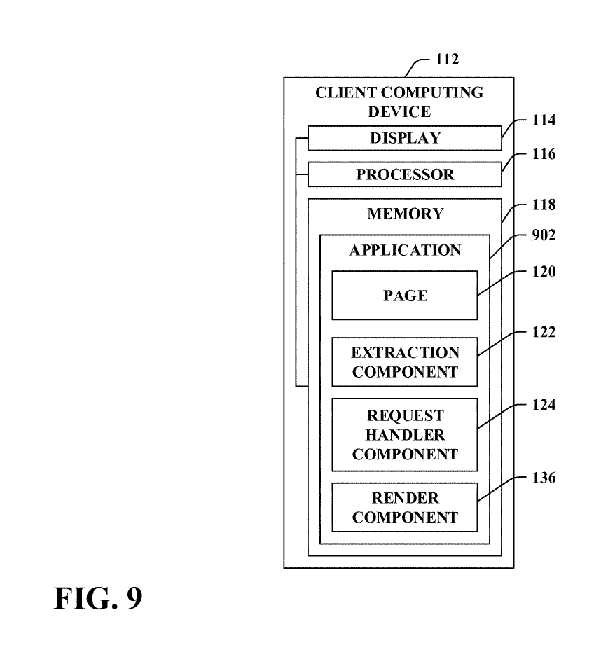

The server computing system 202, for example, can be a web server, which can store, process, and deliver the pages 210 to client computing devices (including the client computing device 112). The memory 206 of the server computing system 202 can include a delivery component 212 configured to communicate with client computing devices and send the pages 210 to the client computing devices. For instance, communication can occur between the client computing device 112 (e.g., a browser component 502 of the client computing device 112 as shown in FIG. 5, an application 902 of the client computing device 112 as shown in FIG. 9) and the delivery component 212 of the server computing system 202. Such communication can take place using the Hypertext Transfer Protocol (HTTP), for example. Moreover, the delivery component 212 can send a page (e.g., the page 120) to the client computing device 112, and the client computing device 112 can receive the page (e.g., the page 120). By way of illustration, the client computing device 112 can initiate communication by making a request for a specific resource (e.g., the page 120) using HTTP and the delivery component 212 can respond with the contents of that resource (or an error message).

Pursuant to an example, the page 120 sent by the delivery component 212 to the client computing device 112 can be a Hypertext Markup Language (HTML) document, which can include images, style sheets, scripts, and text content. The page 120 (e.g., the HTML document), for example, can include a script that causes the request for the transformed third-party content to be generated and sent to the content distribution computing system 102 (e.g., by the request handler component 124) when executed by the client computing device 112. Such script can also cause content to be extracted from the publisher provided content of the page 120 when executed by the client computing device 112 (e.g., by the extraction component 122) and/or cause the transformed third-party content to be inserted amongst the publisher provided content of the page 120 when executed by the client computing device 112 (e.g., by the render component 136).

As described herein, the client computing device 112 sends the request for the page 120 to the content distribution computing system 102, and the content distribution computing system 102 sends the transformed third-party content to the client computing device 112 for native inclusion in the page 120 amongst the publisher provided content responsive to the request. According to an example, it is contemplated that such communication between the client computing device 112 and the content distribution computing system 102 can be routed through the server computing system 202. Pursuant to another example, the communication between the client computing device 112 and the content distribution computing system 102 is not routed through the server computing system 202. In accordance with yet another example, a portion of the communication between the client computing device 112 and the content distribution computing system 102 can be routed through the server computing system 202, and a remainder of the communication between the client computing device 112 and the content distribution computing system 102 is not routed through the server computing system 202.

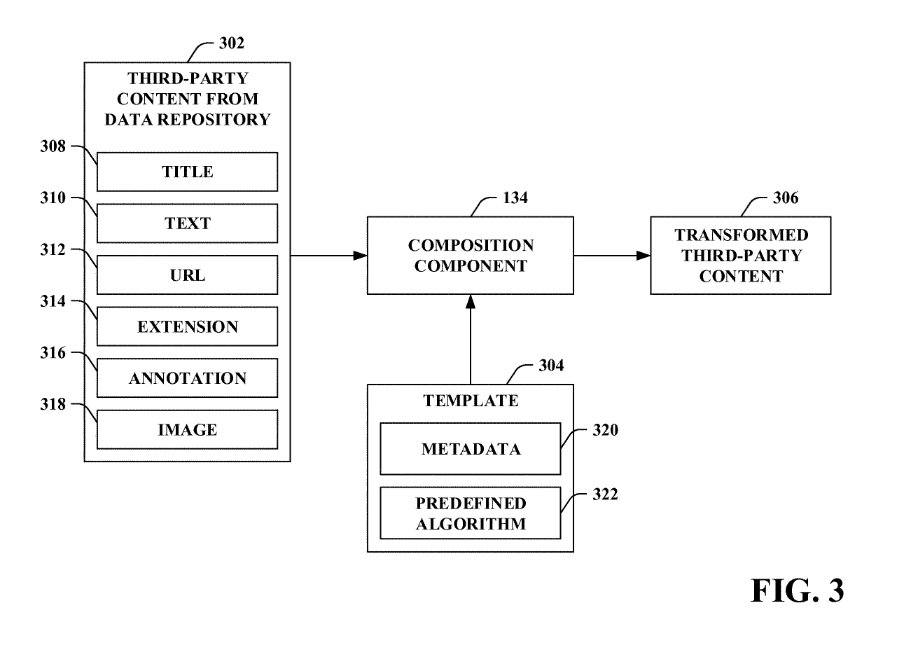

Now turning to FIG. 3, illustrated is the composition component 134 of the content distribution computing system 102 in greater detail. As described herein, the composition component 134 can format third-party content 302 from the data repository according to a template 304 to compose transformed third-party content 306. The third-party content 302 can include multiple strings. For instance, the third-party content 302 can include a title 308 (e.g., a title and a long title), text 310, one or more URLs 312, one or more extensions 314, and one or more annotations 316. The extensions 314 can include actionable links used to make a phone call, open a map for directions, or the like. For instance, the extensions 314 can include a call extension, a location extension, an application, etc. The annotations 316 can include ratings, reviews, or the like. The URLs 312 can include a URL to be displayed, a destination URL, and so forth. Further, the URLs can include links to particular pages within a website. The third-party content 302 can further include one or more images 318. For instance, the images 318 can include an icon, a logo, etc.

As described herein, the third-party content 302 from the data repository can be maintained in a format for inclusion in search engine results pages returned responsive to searches performed by the search engine. For instance, the title 308 can include up to a predetermined maximum number of characters, the text 310 can include up to a predetermined maximum number of characters, the URL to be displayed as part of the search engine results page can include up to a predetermined maximum number of characters, and so forth. Moreover, it is to be appreciated that the third-party content 302 may lack one or more of the elements described above (e.g., the third-party content 302 from the data repository may not include an image, the third-party content 302 from the data repository may not include a long title).

The template 304 can include metadata 320 that specifies a structure to which the transformed third-party content 306 conforms for inclusion in the page of the publisher. The metadata 320 can include dimensions of the transformed third-party content 306, a layout of the transformed third-party content 306, a font for text to be included in the transformed third-party content 306, a number of characters to be included in the transformed third-party content 306, whether in image is to be included in the transformed third-party content 306, a type of the image to be included in the transformed third-party content 306, an image size of the image to be included in the transformed third-party content 306, and so forth.

The template 304 can also include a predefined algorithm 322. The composition component 134 can format the third-party content 302 according to the template 304 to compose the transformed third-party content 306 by identifying a portion of the third-party content 302 selected from the data repository to include in the transformed third-party content 306. The portion of the third-party content can be identified by the composition component 134 based on the predefined algorithm 322 for the template 304. Moreover, the composition component 134 can construct the transformed third-party content 306 to include the portion of the third-party content formatted according to the template 304 as specified by the metadata 320. Meanwhile, a remainder of the third-party content 302 selected from the data repository other than the portion is not included in the transformed third-party content 306 by the composition component 134. Thus, the predefined algorithm 322 can be employed by the composition component 134 to dynamically determine the portion of the third-party content 302 from the data repository to incorporate into the transformed third-party content 306.

The predefined algorithm 322 can control elements of the third-party content 302 from the data repository that are to be included in the template 304 to form the transformed third-party content 306. For example, the predefined algorithm 322 can evaluate numbers of characters included in the title 308, the text 310, the URL 312, the extensions 314, and/or the annotations 316 to choose elements to include in the transformed third-party content 306. According to another example, the predefined algorithm 322 can be utilized to select elements to include based on whether or not the third-party content 302 from the data repository includes the title 308, the text 310, the URL 312, the extensions 314, the annotations 316, and/or the image 318. Thus, the predefined algorithm 322 can be utilized by the composition component 134 to select elements to incorporate into the transformed third-party content 306 to cause the transformed third-party content 306 to natively look like the underlying surface area into which the transformed third-party content 306 is to be inserted in the page of the publisher.

Accordingly, the composition component 134 can utilize the predefined algorithm 322 to determine elements of the third-party content 302 from the data repository to be used for the transformed third-party content 306. Moreover, the predefined algorithm 322 can be employed by the composition component 134 to determine when and how to make such selected elements fit just as publisher provided content within the page of the publisher, so as to conform with the publisher provided content amongst which the transformed third-party content 306 is to be inserted.

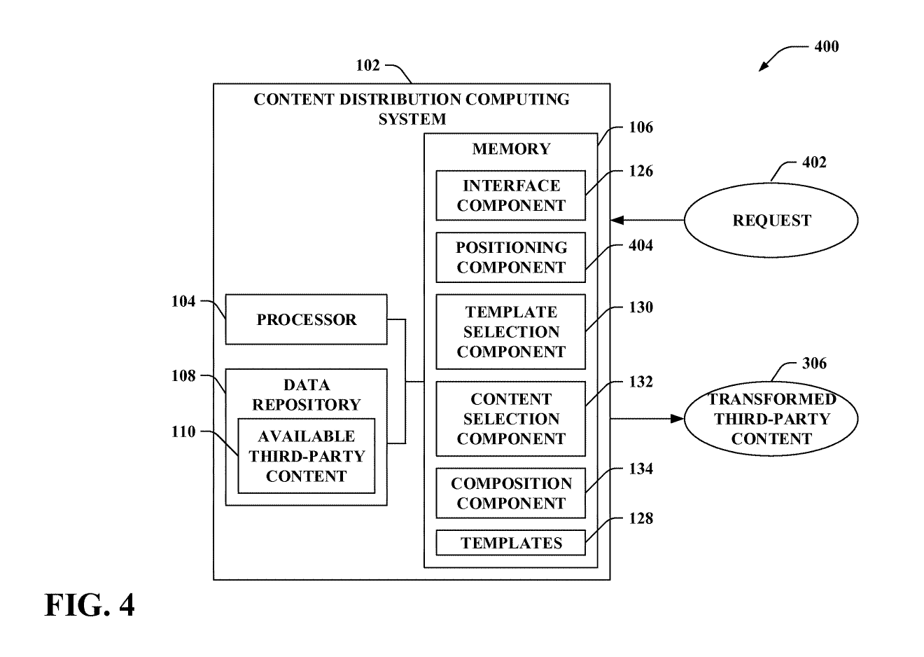

Turning to FIG. 4, illustrated is a system 400 that includes the content distribution computing system 102. The interface component 126 of the content distribution computing system 102 can receive a request 402 for a page of a publisher (e.g., the page 120). As described herein, the request 402 can be generated by a client computing device (e.g., the client computing device 112).

The memory 106 of the content distribution computing system 102 can further include a positioning component 404. In response to receiving the request 402 for the page (e.g., the interface component 126 receiving the request 402), the positioning component 404 can select a location within the page at which the transformed third-party content 306 is to be positioned. The positioning component 404 can determine the location within the page for the transformed third-party content 306 based on a document structure of the page. Moreover, responsive to receiving the request 402 for the page, the template selection component 130 can select a template (e.g., from the templates 128) for the transformed third-party content 306 based on the identity of the publisher of the page, the type of the page, and the location within the page at which the transform third-party content 306 is to be positioned. The transformed third-party content 306 can further be composed by the composition component 134 as described herein. Moreover, the interface component 126 can transmit the transformed third-party content 306 for inclusion at the location within the page by the client computing device.

The client computing device (e.g., the client computing device 112) can receive the transformed third-party content 306 responsive to the request 402. Moreover, the client computing device can identify the location within the page at which the transformed third-party content 306 is to be positioned. The client computing device can identify the location, for example, based on information specifying the location sent along with the transformed third-party content 306. Moreover, the client computing device (e.g., the render component 136) can insert the transformed third-party content 306 amongst the publisher provided content of the page at the location.

According to another example, the client computing device 112 can identify the location by evaluating the document structure of the page. Following this example, the request 402 (e.g., generated and sent by the request handler component 124) can specify the location within the page at which the transformed third-party content 306 is to be positioned. Accordingly, the template for the transformed third-party content can be selected by the template selection component 130 based on the location within the page at which the transformed third-party content 306 is to be positioned as specified in the request 402 (as well as the identity of the publisher of the page and the type of the page). Further following this example, the transformed third-party content 306 constructed by the composition component 134 can be transmitted by the interface component 126 for inclusion at the location within the page by the client computing device.

With reference to FIG. 5, illustrated is the client computing device 112 according to various examples. The memory 118 of the client computing device 112 can include a browser component 502. The browser component 502 can further include the extraction component 122, the request handler component 124, and the render component 136. Following the example shown in FIG. 5, the page 120 can be a webpage of the publisher, where a website of the publisher can include the webpage.

According to an illustration, the browser component 502 can request the page 120 (e.g., a resource) from a server computing system (e.g., the server computing system 202). Responsive to the request, the browser component 502 can receive the page 120. The page 120, for instance, can include a script that can be executed. Execution of such script can cause the request for the page 120 to be generated and sent to a content distribution computing system (e.g., the content distribution computing system 102). Further, in response to sending the request, transformed third-party content for the page 120 can be received and inserted amongst the publisher provided content of the page 120.

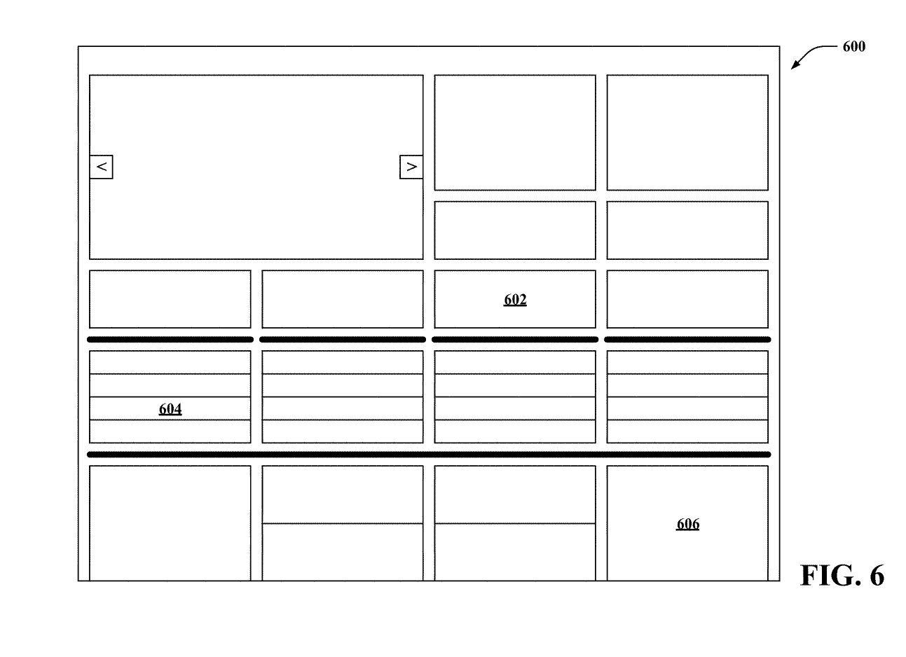

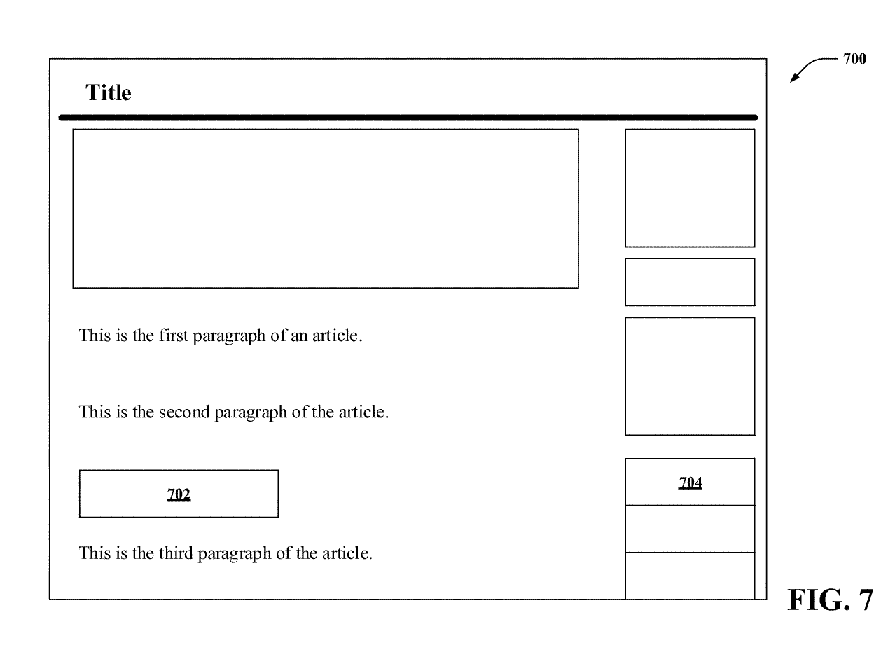

FIGS. 6 and 7 illustrate user interfaces that can be displayed (e.g., on the display 114 of the client computing device 112) for two exemplary predefined types of pages for a publisher. It is to be appreciated that the examples depicted in FIGS. 6 and 7 are shown for illustration purposes, and substantially any predefined type of page for a publisher is intended to fall within the scope of the hereto appended claims. Accordingly, the claimed subject matter is not limited to the examples shown in FIGS. 6 and 7.

Referring to FIG. 6, illustrated is an exemplary user interface 600 for a predefined type of a page of a publisher. The user interface 600, for example, can be for a homepage of the publisher. The user interface 600 includes various regions at differing locations (represented by rectangular boundaries, which may or may not be displayed).

The page includes publisher provided content. Moreover, as described herein, transformed third-party content can be received for native inclusion amongst the publisher provided content (e.g., the transformed third-party content can be composed based on an identity of the publisher and the type of the page). According to an example, transformed third-party content A can be received for native inclusion in the region 602 of the user interface 600. Further following this example, transformed third-party content B can be received for native inclusion in the region 604 of the user interface 600 and transformed third-party content C can be received for native inclusion in the region 606. Other regions of the user interface 600 can include publisher provided content. Thus, the transformed third-party content A, the transformed third-party content B, and the transformed third-party content C can be inserted amongst the publisher provided content. Moreover, appearances of the transformed third-party content A, the transformed third-party content B, and the transformed third-party content C can conform with the publisher provided content included in the user interface 600 of the page.

Further, the transformed third-party content A can be formatted based on being inserted in the region 602, the transformed third-party content B can be formatted based on being inserted in the region 604, and the transformed third-party content C can be formatted based on being inserted in the region 606. For instance, different templates can be selected for formatting third-party content for the region 602 as compared to the region 604 (as well as compared to region 606). It is contemplated that transformed third-party content can be natively included in any of the regions of the user interface 600 for the page. Moreover, substantially any number of regions of the user interface 600 can include transformed third-party content (e.g., the claimed subject matter is not limited to three regions including transformed third-party content).

FIG. 7 illustrates an exemplary user interface 700 of another predefined type of a page of the publisher. The user interface 700, for example, can be for an article page of the publisher. Thus, the user interface 700 includes an article (e.g., at least a portion of the publisher provided content). Moreover, the user interface 700 includes other regions at different locations.

In the example set forth in FIG. 7, transformed third-party content can be formatted for inclusion between paragraphs of the article in the region 702. The transformed third-party content can be generally relevant to the article. Moreover, it is contemplated that the transformed third-party content for inclusion in the region 702 can be relevant to the second paragraph and/or the third paragraph of the article (which are adjacent to the region 702 of the user interface 700 in which the transformed third-party content is inserted). For instance, snippets can be extracted from the second paragraph and/or the third paragraph of the article and included as part of the request for the transformed third-party content sent to the content distribution computing system 102 for the page shown in FIG. 7.

Moreover, as shown in FIG. 7, disparate transformed third-party content can also be received for native inclusion in the region 704 of the user interface 700. Again, it is contemplated that other regions of the user interface 700 can include publisher provided content. It is to be appreciated that substantially any region of the user interface 700 can include transformed third-party content, and the claimed subject matter is not limited to the example shown in FIG. 7.

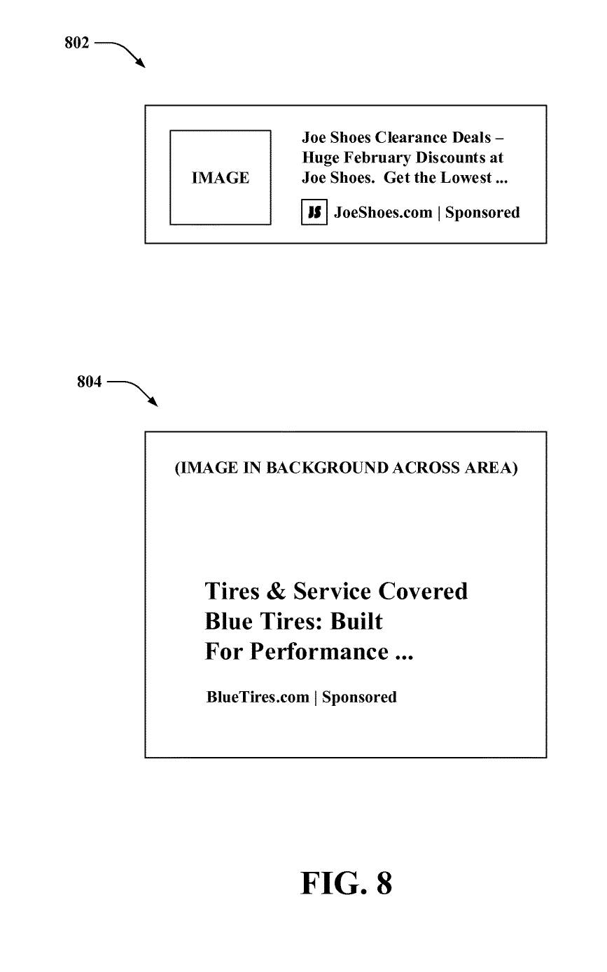

Turning to FIG. 8, illustrated are two exemplary templates for third-party content to be included in pages amongst publisher provided content. It is to be appreciated that the examples shown in FIG. 8 are provided for illustration purposes, and the claimed subject matter is not limited to these examples. For instance, substantially any other predefined template is intended to fall within the scope of the hereto appended claims.

A template 802 includes an image and three lines of text selected from third-party content from the data repository. The three lines of text can be from a long title of the third-party content (if the third-party content in the data repository includes a long title). Moreover, the template 802 includes a logo and a displayed URL.

A template 804 includes an image that extends in the background across an area of the template 804. The template 804 further includes three lines of text and a displayed URL.

As described herein, elements from third-party content in the data repository 108 of the content distribution computing system 102 included in the templates can be identified using predefined algorithms for each of the templates. Moreover, the structures of the templates can be controlled based on metadata for each of the templates.

Turning to FIG. 9, illustrated is another example of the client computing device 112. As depicted in FIG. 9, the memory 118 of the client computing device 112 includes an application 902. The application 902 includes the extraction component 122, the request handler component 124, and the render component 136. The application 902 is an application of a publisher, and includes the page 120. The application 902 can be executable by the at least one processor 116 of the client computing device 112. Pursuant to an example, the application 902 can request the page 120 from a server computing system (e.g., the server computing system 202), and the page 120 can be received responsive to the request.

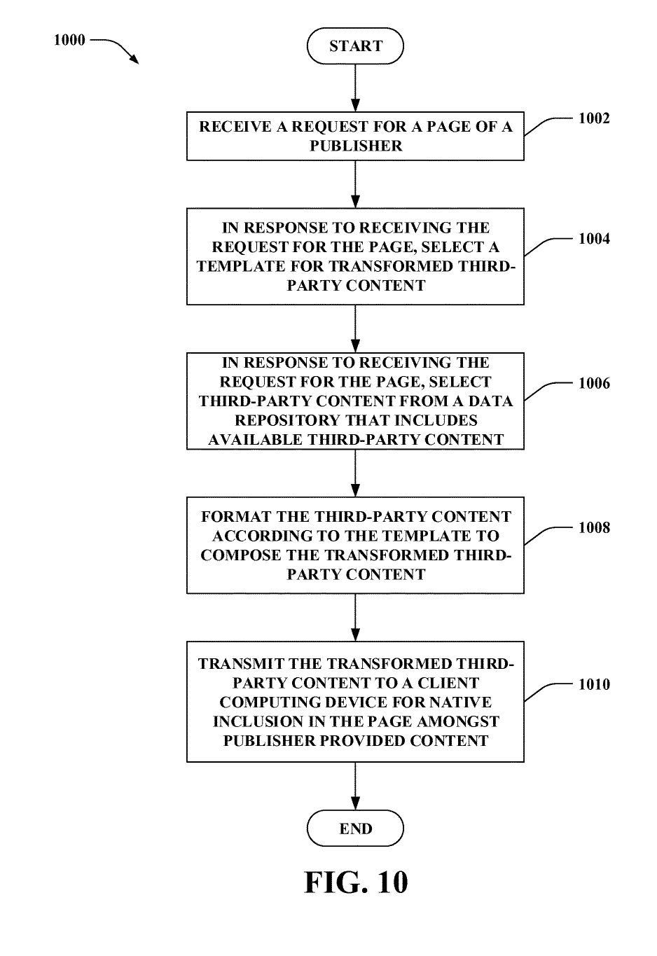

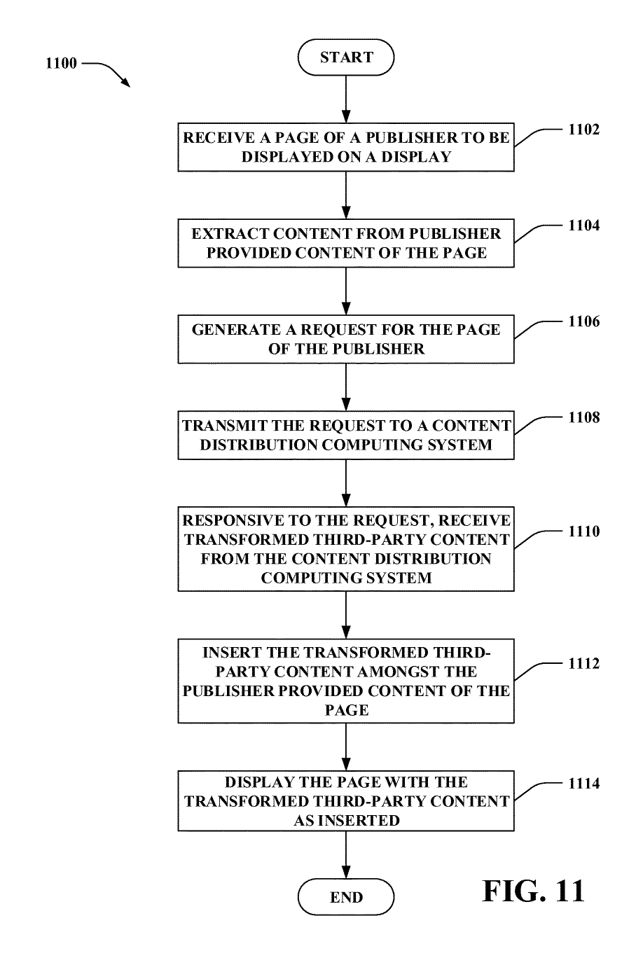

FIGS. 10-11 illustrate exemplary methodologies relating to transforming third-party content for native inclusion in a page amongst publisher provided content. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 10 illustrates a methodology 1000 of creating transformed third-party content for inclusion in a page of a publisher. The page is to be displayed on a client computing device. At 1002, a request for the page of the publisher can be received. The request can be generated by the client computing device. At 1004, in response to receiving the request for the page, a template for the transformed third-party content can be selected based on an identity of the publisher of the page and a type of the page. The type of the page can be one of a plurality of predefined types of pages. At 1006, in response to receiving the request for the page, third-party content can be selected from a repository that includes available third-party content. The third-party content can be selected based on publisher provided content in the page. Moreover, the third-party content can be selected based on search history of a user of the client computing device, browsing history of the user of the client computing device, and so forth. At 1008, the third-party content can be formatted according to the template to compose the transformed third-party content. At 1010, the transformed third-party content can be transmitted to the client computing device for native inclusion in the page amongst the publisher provided content.

Now turning to FIG. 11, illustrated is a methodology 1100 of requesting transformed third-party content for native inclusion amongst publisher provided content of a page of a publisher. At 1102, a page to be displayed on a display can be received at a client computing device. The page can be from a publisher. Moreover, the page can include publisher provided content. At 1104, content from the publisher provided content of the page can be extracted. At 1106, a request for the page of the publisher can be generated. The request can include the extracted content. Moreover, the request can include an identifier specifying a user of the client computing device, an IP address of the page, a URL of the page, and so forth. At 1108, the request can be transmitted by the client computing device to a content distribution computing system. At 1110, responsive to the request, transformed third-party content can be received by the client computing device from the content distribution computing system. The transformed third-party content can be relevant to the extracted content and can be formatted for native inclusion in the page of the publisher. At 1112, the transformed third-party content can be inserted amongst the publisher provided content of the page. The transformed third-party content can have an appearance that conforms with the publisher provided content amongst which the transformed third-party content is inserted in the page. At 1114, the page with the transformed third-party content as inserted can be displayed on the display.

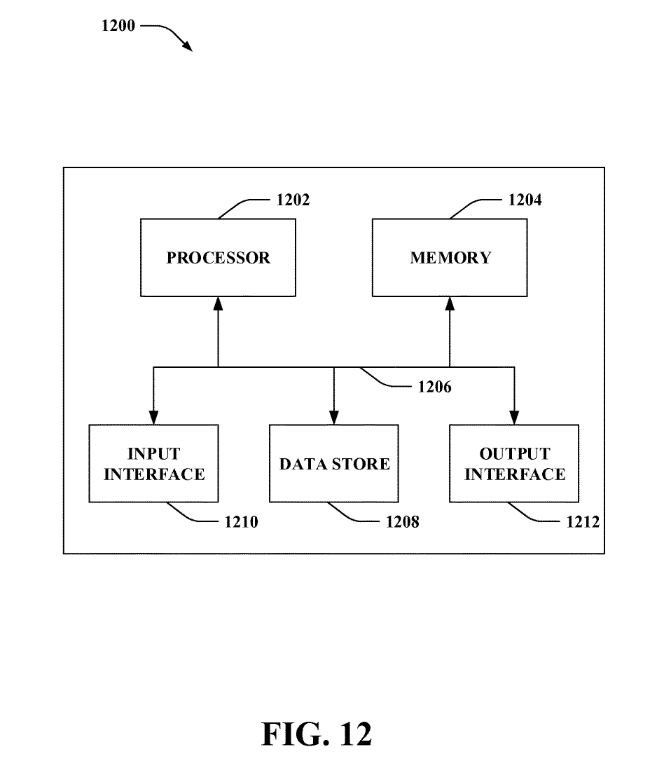

Referring now to FIG. 12, a high-level illustration of an exemplary computing device 1200 that can be used in accordance with the systems and methodologies disclosed herein is illustrated. For instance, the computing device 1200 may be used in the content distribution computing system 102. According to another example, the computing device 1200 may be used in the server computing system 202. Pursuant to another example, the computing device 1200 may be the client computing device 112. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory 1204 by way of a system bus 1206. In addition to storing executable instructions, the memory 1204 may also store third-party content, pages, templates, transformed third-party content, and so forth.

The computing device 1200 additionally includes a data store 1208 that is accessible by the processor 1202 by way of the system bus 1206. The data store 1208 may include executable instructions, third-party content, pages, templates, transformed third-party content, etc. The computing device 1200 also includes an input interface 1210 that allows external devices to communicate with the computing device 1200. For instance, the input interface 1210 may be used to receive instructions from an external computer device, from a user, etc. The computing device 1200 also includes an output interface 1212 that interfaces the computing device 1200 with one or more external devices. For example, the computing device 1200 may display text, images, etc. by way of the output interface 1212.

It is contemplated that the external devices that communicate with the computing device 1200 via the input interface 1210 and the output interface 1212 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1200 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1200 may be a distributed system. Thus, for instance, several devices may be in communication by way of a network connection and may collectively perform tasks described as being performed by the computing device 1200.

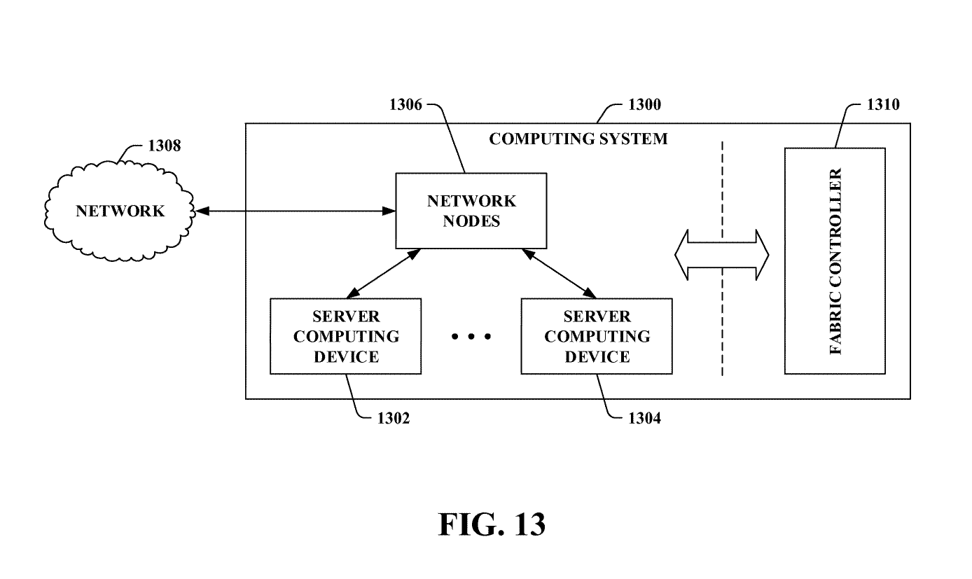

Turning to FIG. 13, a high-level illustration of an exemplary computing system 1300 that can be used in accordance with the systems and methodologies disclosed herein is illustrated. For instance, the computing system 1300 can be or include the content distribution computing system 102. Additionally or alternatively, the content distribution computing system 102 can be or include the computing system 1300. By way of another example, the computing system 1300 can be or include the server computing system 202. Additionally or alternatively, the server computing system 202 can be or include the computing system 1300.

The computing system 1300 includes a plurality of server computing devices, namely, a server computing device 1302, . . . , and a server computing device 1304 (collectively referred to as server computing devices 1302-1304). The server computing device 1302 includes at least one processor and a memory; the at least one processor executes instructions that are stored in the memory. The instructions may be, for instance, instructions for implementing functionality described as being carried out by one or more components discussed above or instructions for implementing one or more of the methods described above. Similar to the server computing device 1302, at least a subset of the server computing devices 1302-1304 other than the server computing device 1302 each respectively include at least one processor and a memory. Moreover, at least a subset of the server computing devices 1302-1304 include respective data stores.

Processor(s) of one or more of the server computing devices 1302-1304 can be or include the processor 104. Further, a memory (or memories) of one or more of the server computing devices 1302-1304 can be or include the memory 106. Moreover, a data store (or data stores) of one or more of the server computing devices 1302-1304 can be or include the data repository 108. According to another example, processor(s) of one or more of the server computing devices 1302-1304 can be or include the processor 204. Following this example, a memory (or memories) of one or more of the server computing devices 1302-1304 can be or include the memory 206. Further pursuant to this example, a data store (or data stores) of one or more of the server computing devices 1302-1304 can be or include the data repository 208.

The computing system 1300 further includes various network nodes 1306 that transport data between the server computing devices 1302-1304. Moreover, the network nodes 1302 transport data from the server computing devices 1302-1304 to external nodes (e.g., external to the computing system 1300) by way of a network 1308. The network nodes 1302 also transport data to the server computing devices 1302-1304 from the external nodes by way of the network 1308. The network 1308, for example, can be the Internet, a cellular network, or the like. The network nodes 1306 include switches, routers, load balancers, and so forth.

A fabric controller 1310 of the computing system 1300 manages hardware resources of the server computing devices 1302-1304 (e.g., processors, memories, data stores, etc. of the server computing devices 1302-1304). The fabric controller 1310 further manages the network nodes 1306. Moreover, the fabric controller 1310 manages creation, provisioning, de-provisioning, and supervising of virtual machines instantiated upon the server computing devices 1302-1304.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of creating transformed third-party content for inclusion in a page of a publisher, the page to be displayed on a client computing device, the method comprising:
receiving a request for the page of the publisher, the request being generated by the client computing device;
in response to receiving the request for the page, selecting a template for the transformed third-party content based on an identity of the publisher of the page and a type of the page, the type of the page being one of a plurality of predefined types of pages;
in response to receiving the request for the page, selecting third-party content from a data repository comprising available third-party content, the third-party content selected based on publisher provided content in the page;
formatting the third-party content according to the template to compose the transformed third-party content; and
transmitting the transformed third-party content to the client computing device for native inclusion in the page amongst the publisher provided content.

2. The method of claim 1, further comprising:
in response to receiving the request for the page, selecting a location within the page at which the transformed third-party content is to be positioned;
wherein the template for the transformed third-party content is further selected based on the location within the page at which the transformed third-party content is to be positioned; and
wherein the transformed third-party content is transmitted for inclusion at the location within the page by the client computing device.

3. The method of claim 1, wherein:
the request specifies a location within the page at which the transformed third-party content is to be positioned;
the template for the transformed third-party content is further selected based on the location within the page at which the transformed third-party content is to be positioned; and
the transformed third-party content is transmitted for inclusion at the location within the page by the client computing device.

4. The method of claim 1, wherein formatting the third-party content according to the template to compose the transformed third-party content further comprises:
composing the transformed third-party content based on the third-party content selected from the data repository, the transformed third-party content having an appearance that conforms with the publisher provided content amongst which the transformed third-party content is to be included in the page.

5. The method of claim 4, wherein the third-party content selected from the data repository comprises plain text content.

6. The method of claim 1, wherein the available third-party content in the data repository is maintained in a format for inclusion in search engine results pages returned responsive to searches performed by a search engine.

7. The method of claim 1, wherein the template is selected from a plurality of predefined templates for the publisher.

8. The method of claim 1, wherein the template comprises metadata that specifies a structure to which the transformed third-party content conforms for inclusion in the page of the publisher.

9. The method of claim 1, wherein the template comprises metadata that specifies one or more of:
dimensions of the transformed third-party content;
a layout of the transformed third-party content;
a font for text to be included in the transformed third-party content;
a number of characters to be included in the transformed third-party content;
whether an image is to be included in the transformed third-party content;
a type of the image to be included in the transformed third-party content; or
an image size of the image to be included in the transformed third-party content.

10. The method of claim 1, wherein:
the request comprises extracted content, the extracted content being extracted by the client computing device from the publisher provided content in the page; and
the third-party content being selected from the data repository comprising the available third-party content based on the extracted content.

11. The method of claim 1, wherein formatting the third-party content according to the template to compose the transformed third-party content further comprises:
identifying a portion of the third-party content selected from the data repository to include in the transformed third-party content, the portion of the third-party content being selected based on a predefined algorithm for the template; and
constructing the transformed third-party content to include the portion of the third-party content formatted according to the template, wherein a remainder of the third-party content selected from the data repository other than the portion is not included in the transformed third-party content.

12. The method of claim 1, wherein the transformed third-party content is maintained in a format for inclusion between paragraphs of an article included in the page.

13. The method of claim 1, wherein the third-party content is further selected from the data repository comprising the available third-party content based on one or more of search history of a user of the client computing device or browsing history of the user of the client computing device.

14. A client computing device, comprising:
a display;
at least one processor; and
memory that comprises computer-executable instructions that, when executed by the at least one processor, cause the at least one processor to perform acts including:
receiving a page to be displayed on the display, the page being from a publisher, the page comprises publisher provided content;
extracting content from the publisher provided content of the page;
generating a request for the page of the publisher, the request comprises the extracted content;
transmitting the request to a content distribution computing system;
responsive to the request, receiving transformed third-party content from the content distribution computing system, the transformed third-party content being relevant to the extracted content and formatted for native inclusion in the page of the publisher;
inserting the transformed third-party content amongst the publisher provided content of the page, the transformed third-party content having an appearance that conforms with the publisher provided content amongst which the transformed third-party content is inserted in the page; and
displaying, on the display, the page with the transformed third-party content as inserted.

15. The client computing device of claim 14, wherein the request further comprises one or more of an identifier specifying a user of the client computing device, an Internet Protocol (IP) address of the page, or a Uniform Resource Locator (URL) of the page.

16. The client computing device of claim 14, the memory further comprising computer-executable instructions that, when executed by the at least one processor, cause the at least one processor to perform acts including:
receiving input specifying a user selection of the transformed third-party content inserted in the page; and
responsive to the input, retrieving a web resource at a destination Uniform Resource Locator (URL) specified by the transformed third-party content.

17. The client computing device of claim 14, wherein a website of the publisher comprises the page.

18. The client computing device of claim 14, wherein an application of the publisher comprises the page, the application being executable by the at least one processor.

19. The client computing device of claim 14, the memory further comprising computer-executable instructions that, when executed by the at least one processor, cause the at least one processor to perform acts including:
identifying a location within the page at which the transformed third-party content is to be positioned; and
inserting the transformed third-party content amongst the publisher provided content of the page at the location.

20. A content distribution computing system, comprising:
a data repository that comprises available third-party content, the available third-party content in the data repository being maintained in a format for inclusion in search engine results pages returned responsive to searches performed by a search engine;
at least one processor; and
memory that comprises computer-executable instructions that, when executed by the at least one processor, cause the at least one processor to perform acts including:
selecting a template for transformed third-party content for inclusion in a page of a publisher, the page to be displayed on a client computing device, the template being selected based on an identity of the publisher of the page and a type of the page, the type of the page being one of a plurality of predefined types of pages;
selecting third-party content from the available third-party content in the data repository;
formatting the third-party content according to the template to compose the transformed third-party content; and
transmitting the transformed third-party content to the client computing device for native inclusion in the page amongst publisher provided content in the page.
